(19) United States
(12) Patent Application Publication
(10) Pub. No.: US 2008/0128085 A1
(43) Pub. Date: Jun. 5, 2008

(54) Surface Treating Apparatus For Square Wafer For Solar Battery

(75) Inventors: Masato Tsuchiya, Gunma (JP); Syunichi Ogasawara, Gunma (JP)

Correspondence Address: MARGER JOHNSON & MCCOLLOM, P.C., 210 SW MORRISON STREET, SUITE 400, PORTLAND, OR, 97204, US

(73) Assignee: MIMASU SEMICONDUCTOR INDUSTRY CO., LTD., Takasaki-shi, Gunma (JP)

(21) Appl. No.: 11/719,985

(22) PCT Filed: Dec. 1, 2004
(86) PCT No.: PCT/JP04/17867

§ 371 Date: May 23, 2007

(51) Int. Cl. C23F 1/08; B05C 11/08; B08B 3/00; F26B 17/30

(52) U.S. Cl. 156/345.23; 156/345.55; 118/52; 134/153; 34/58

(57) ABSTRACT

According to the present invention, when performing spin treatment on a square wafer for a solar battery, it is possible to prevent the treatment medium, which is caused to flow down onto the surface of the wafer and scattered to the outside of the wafer from the four sides thereof in droplets, from reaching the back surface of the wafer. A surface treating apparatus for a square wafer for a solar battery according to the present invention includes: a rotating disc capable of rotating at a predetermined speed; a wafer holding part protruding from the central portion of the upper surface of the rotating disc and adapted to hold a square wafer; a flow-down nozzle for supplying the treatment medium onto a surface of the square wafer from above the wafer holding part in a downflow; and four correction plates provided upright on the rotating disc so as to be situated outward respectively in correspondence with the four sides of the square wafer when the square wafer is held by the wafer holding part; when, with the square wafer being held by the wafer holding part, the rotating disc is rotated and the treatment medium is caused to flow down onto the surface of the square wafer, it is possible to prevent the treatment medium from reaching the back surface of the square wafer.

### TECHNICAL FIELD

The present invention relates to an apparatus which, when performing spin treatment on the surface of a square semiconductor wafer of a silicon single crystal, a silicon polycrystal or the like for use in a solar cell (hereinafter referred to as a square wafer for a solar battery or simply as a square wafer) by using a treatment medium such as a treatment liquid, a cleaning liquid or a gas, can prevent the flow of the treatment medium such as a liquid flow or a gas flow, which is caused to flow down onto the surface of the square wafer, from reaching the back surface of the square wafer.

### BACKGROUND ART

The surface treatment to be performed on a square wafer in a solar cell manufacturing process includes, apart from an etching processing for removing a damaged layer, application of various solvents to the square wafer, cleaning of the surface of the square wafer, etc. Conventionally, the apparatus used for the surface treatment of such a square wafer has been one similar to an apparatus used for the surface treatment of ordinary, round wafers, which apparatus is composed of a wafer rotating/holding device for chucking and rotating a round wafer, a treatment liquid supply means for supplying the requisite treatment liquid (chemical solution) onto the upper surface of the chucked round wafer, a cleaning liquid supply means for supplying a cleaning liquid onto the upper surface of the round wafer, etc. (Patent Document 1).

Here, FIG. 7 is an explanatory perspective view showing a case in which a conventional wafer surface treating apparatus is applied to the surface treatment of a square wafer, and FIG. 8 is a schematic view showing the condition of the back surface of the square wafer on which surface treatment has been conducted by the conventional wafer surface treating apparatus. In the drawings, reference symbol 10a indicates a conventional wafer surface treating apparatus, and reference numeral 20 indicates a square wafer. The conventional wafer surface treating apparatus 10a is equipped with a rotating disc 12 adapted to rotate at a predetermined speed, a wafer holding part 14 protruding from the center of the upper surface thereof and serving to hold the square wafer 20, and a flow-down nozzle 16 for supplying a treatment medium onto the surface of the square wafer 20 from above in a downflow; while the rotating disc 12 is being rotated, a treatment medium 22 is supplied from the flow-down nozzle 16 in a downflow onto the square wafer 20, whereby surface treatment is conducted on the square wafer 20 (FIG. 7). The square wafer 20 has four sides composed of sides 24a, 24b, 24c, and 24d, and four corners composed of beveled corner portions 25a, 25b, 25c, and 25d (FIG. 8).

It should be noted, however, that, in the case in which the square wafer 20 is treated by the conventional wafer surface treating apparatus 10a, which is similar to the apparatus for the surface treatment of round wafers as described above, due to the square (rectangular) configuration of the square wafer 20, a liquid flow F of the treatment medium 22 such as a treatment liquid or a cleaning liquid, caused to flow down onto the surface of the square wafer 20, and a gas flow such as an airflow, make a peculiar movement at the side 24a, 24b, 24c, and 24d of the square wafer 20, and the liquid, etc. are scattered to the outside of the wafer in droplets S (FIG. 7); due to the influence of such an irregular liquid flow and gas flow at the sides 24a, 24b, 24c, and 24d of the square wafer 20, there is a problem in that, the liquid flow such as the treatment liquid or the cleaning liquid and the gas flow such as an airflow, are allowed to reach portions B on the back side of the corner portions 25a, 25b, 25c, and 25d of the square wafer 20 (FIG. 8). In view of this, there are taken various measures to protect the back surface, such as formation of a protective film on the back surface of the square wafer 20 and attachment of a protective tape thereto; such measures, however, involve an increase in the number of manufacturing steps and generation of consumables, resulting in deterioration in productivity.

When performing surface treatment on a round wafer with an orientation flat, the treatment medium caused to flow down onto the surface of the round wafer, such as a liquid flow of a treatment liquid of a cleaning liquid, and a gas flow such as an airflow, make a peculiar movement at the orientation flat portion, and due to the influence of the resulting irregular liquid flow and gas flow, there is a problem in that, the liquid flow such as the treatment liquid or the cleaning liquid and the gas flow such as the airflow, are allowed to reach the back surface of the round wafer. To solve this problem, the present inventors have already proposed a wafer surface treating apparatus which is composed of: a rotating disc; a wafer holding part provided at the center of the upper surface of the rotating disc and adapted to hold a round wafer with an orientation flat; a flow-down nozzle for supplying a treatment medium onto the surface of the round wafer in a downflow; and a correction plate provided upright so as to be spaced apart from the orientation flat portion of the round wafer when the round wafer is held by the wafer holding part, in which, when, with the wafer being held by the wafer holding part, the rotating disc is rotated and the treatment medium is caused to flow down onto the surface of the wafer, it is possible to prevent the treatment medium from reaching the back surface of the wafer (Patent Document 2). However, while applicable to a round wafer with an orientation flat, this proposed apparatus cannot be applied to a square wafer for a solar battery.

Patent Document 1: JP 08-88168 A

Patent Document 2: JP 2003-86555 A

### DISCLOSURE OF THE INVENTION

### Problem to be solved by the Invention

The present invention has been made in view of the above-mentioned problem in the prior art. It is therefore an object of the present invention to provide a surface treating apparatus for a square wafer for a solar battery which can, when performing spin treatment on a square wafer for a solar battery, prevent the treatment medium, which is caused to flow down onto the surface of the wafer and scattered to the outside of the wafer in droplets from the four sides thereof, from reaching the back surface of the wafer.

### Means for Solving the Problem

To solve the above-mentioned problem, according to the present invention, there is provided a surface treating apparatus for a square wafer for a solar battery for performing surface treatment on the square wafer for the solar battery, including: a rotating disc capable of rotating at a predetermined speed; a wafer holding part protruding from a central portion of an upper surface of the rotating disc and adapted to hold a square wafer; a flow-down nozzle for supplying a treatment medium onto a surface of the square wafer in a downflow from above the wafer holding part; and four correction plates provided upright on the rotating disc so that the four correction plates are situated outward respectively in correspondence with four sides of the square wafer when the square wafer is held by the wafer holding part, wherein, when, with the square wafer being held by the wafer holding part, the rotating disc is rotated and the treatment medium is caused to flow down onto the surface of the square wafer, it is possible to prevent the treatment medium from reaching the back surface of the square wafer.

It is appropriate that: the four correction plates be provided upright such that, when the square wafer is held by the wafer holding part, a forward end in a rotating direction of each of the four correction plates meet a straight line passing a center of the square wafer being held and a middle point between the forward end in the rotating direction and a rear end in the rotating direction of corresponding one of four sides of the wafer or is situated in the vicinity of the straight line, and is spaced apart by a predetermined distance d from the middle point between the forward end in the rotating direction and the rear end in the rotating direction of each of the four sides; and that the rear end in the rotating direction of each of the four correction plates be inclined by a predetermined inclination angle α so that the four correction plates are spaced apart from the corresponding one of the four sides.

It is preferable that, when the square wafer is held by the wafer holding part, the rear end in the rotating direction of each of the four correction plates extends beyond a virtual circumference C of the square wafer. As a result, there is an advantage in that it is possible to reliably correct the treatment medium scattered in droplets from the four sides of the square wafer.

A surface treating apparatus for a square wafer for a solar battery has a structure in which a length L₁ of each of the four correction plates is 50% or more of a length L₂ of the corresponding one of the four sides.

It is appropriate that the predetermined distance d be a length which is 0 mm or more but is not beyond the virtual circumference C of the square wafer.

It is preferable that, when the square wafer is held by the wafer holding part, the forward end in the rotating direction of each of the four correction plates be situated on a front side with respect to the rotating direction by 0 to 2 mm from the straight line passing the center of the square wafer being held and the middle point between the forward end in the rotating direction and the rear end in the rotating direction of the corresponding one of the four sides of the square wafer.

When the predetermined inclination angle α is approximately 0° to 90°, it is possible to correct the treatment medium flow on the wafer surface, and the inclination angle α is set as appropriate according to the rotating speed; more preferably, the inclination angle α is set at 5° to 60°, and most preferably, at 5° to 35°.

When the square wafer is held by the wafer holding part, it is desirable for the height h₁ of the four correction plates to be larger than the surface height h₂ of the held square wafer by 0.5 mm or more. By adopting this arrangement, it is possible for all droplets of the treatment medium, which are scattered from the four sides of the square wafer, to hit the correction plates to thereby reliably correct the treatment medium flow.

Examples of the surface treatment to be conducted on a square wafer for a solar battery include spin rinsing, spin etching, spin drying, and spin coating.

The treatment medium may be a gas and/or a liquid; that is, the treatment medium may be a gas alone, such as air, or a liquid alone, such as pure water or chemical solution, or a mixture of both.

### EFFECT OF THE INVENTION

In the surface treating apparatus for a square wafer for a solar battery of the present invention described above, when performing spin treatment on a square wafer for a solar battery, it is advantageously possible to prevent the treatment medium, which is caused to flow down onto the surface of the wafer and is scattered to the outside of the wafer in droplets, from reaching the back surface of the wafer.

### BEST MODE FOR CARRYING OUT THE INVENTION

In the following, an embodiment of the present invention will be described with reference to the accompanying drawings. It goes without saying that the embodiment allows various modifications and variations without departing from the technical idea of the present invention.

FIG. 1 is an explanatory perspective view of an example of the surface treating apparatus for a square wafer for a solar battery of the present invention. FIG. 2 is an explanatory plan view of FIG. 1. FIG. 3 is an explanatory perspective view illustrating how a square wafer is held by the surface treating apparatus for a square wafer for a solar battery of the present invention. FIG. 4 is an explanatory plan view of FIG. 3. FIG. 5 is an explanatory plan view showing the positional relationship between the square wafer and the correction plates in the surface treating apparatus for a square wafer for a solar battery of the present invention. FIG. 6 is an explanatory enlarged main portion sectional view of the surface treating apparatus for a square wafer for a solar battery of the present invention. In the drawings, numeral 10 indicates the surface treating apparatus for a square wafer for a solar battery. The components and portions that are the same as or equivalent to those of the above-mentioned conventional example shown in FIGS. 7 and 8 are indicated by the same or equivalent reference numerals.

The surface treating apparatus 10 for a square wafer for a solar battery of the present invention is equipped with a rotating disc 12 capable of rotating at a predetermined speed, a wafer holding part 14 protruding from the center of the upper surface thereof and adapted to hold a square wafer 20, a flow-down nozzle 16 for supplying a treatment medium onto the surface of the square wafer 20 from above in a downflow, and four correction plates 18a, 18b, 18c, and 18d provided upright on the rotating disc 12 so as to be situated outward respectively in correspondence with four sides 24a, 24b, 24c, and 24d of the square wafer 20 when the square wafer 20 is held by the wafer holding part 14 (FIGS. 1 through 3); while the rotating disc 12 is being rotated, a treatment medium 22 is supplied onto the surface of the square wafer 20 in a downflow from the flow-down nozzle 16. The square wafer 20 is a square semiconductor wafer for a solar battery, and has four sides composed of the sides 24a, 24b, 24c, and 24d and four corners composed of beveled corner portions 25a, 25b, 25c, and 25d (FIGS. 4 and 5).

The rotating disc 12 can be rotated at a predetermined speed as appropriate. The wafer holding part 14 is a so-called wafer chuck; while there are no particular limitations regarding the type of the holding part as long as the holding part can hold the square wafer 20, it is possible to adopt an electrostatic chuck type holding part, a vacuum chuck type holding part, etc.

The flow-down nozzle 16 serves to supply the treatment medium 22 in a downflow onto the surface of the wafer 20; by providing the flow-down nozzle 16 so as to be movable, for example, vertically or horizontally, with respect to the rotating disc 12, it is also possible to adjust the supply intensity and the supply position of the treatment medium 22.

The correction plates 18a, 18b, 18c, and 18d are small plate-like members; there are no particular limitations regarding the material thereof. The correction plates 18a through 18d are provided upright on the rotating disc 12 so as to be situated outward respectively in correspondence with the sides 24a, 24b, 24c, and 24d constituting the four sides of the square wafer 20 when the square wafer 20 is held by the wafer holding part 14.

That is, as is well shown in FIG. 4, in the case of the correction plate 18a, it is provided upright such that, when the square wafer 20 is held by the wafer holding part 14, the forward end in the rotating direction of the correction plate 18a meets a straight line M₁ obtained by extending outward the straight line connecting a center O of the square wafer 20 and a middle point G of the side 24a between the forward end in the rotating direction and the rear end in the rotating direction thereof (FIG. 4).

Further, the correction plate 18a is provided upright at a predetermined distance d from the middle point G of the side 24a. In other words, the correction plate 18a is provided upright such that the forward end in the rotating direction of the correction plate 18a is situated in a line P₂ parallel to and spaced apart by the predetermined distance d from a line P₁ coinciding with the side 24a (FIG. 4). It is only necessary for the predetermined distance d to be 0 mm or more (which corresponds to the state in which the forward end in the rotating direction of the correction plate 18a is in contact with the side 24a) but not so large as to be beyond a virtual circumference C of the square wafer 20; preferably, the predetermined distance d ranges from 0.2 to 1.0 mm, and more preferably, is approximately 1 mm.

Further, the correction plate 18a is provided upright so as to be inclined at a predetermined angle α so that the rear end in the rotating direction thereof is spaced apart from the side 24a. In other words, the correction plate 18a is provided upright at a position where the rear end in the rotating direction thereof is inclined at the inclination angle α with respect to the line P₂, which is parallel to the line P₁, which coincides with the side 24a (FIG. 4). When the inclination angle α is approximately 0° to 90°, it is possible to correct the treatment medium flow onto the surface of the square wafer 20; more preferably, the angle ranges from 5° to 60°, and most preferably, approximately from 5′ to 35°.

Further, the rear ends in the rotating direction of the correction plates 18 extend (outward) beyond the virtual circumference C of the square wafer (FIG. 4). This makes it possible to reliably effect correction on the treatment medium, which is scattered in droplets from the four sides of the square wafer 20, such that it moves outward away therefrom.

While in the case described with reference to FIGS. 1 through 4 the forward end in the rotating direction of the correction plate 18a meets the straight line M₁, it is also possible, as shown in FIG. 5, for the forward end to be situated on the front side of the straight line M₁ with respect to the rotating direction of the correction plate 18a by 0 to 2 mm. In other words, it is possible to set a width W by which the forward end in the rotating direction of the correction plate 18a is offset forward from the straight line M₁ at approximately 0 to 2 mm (FIG. 5).

It is desirable for a length L₁ of the correction plate 18a to be approximately not less than 50% but not more than 100% of the length L₂ of the side 24a (FIG. 5), and as shown in FIG. 6, a height h₁ of the correction plate 18a is made larger than a height h₂ of the wafer 20 held by the rotating disc 12; preferably, it is larger than the surface height h₂ by approximately 0.5 to 3.0 mm (FIG. 6). For example, when the height of the surface of the wafer 20 is 2.0 mm, the height of the correction plate 18a is set to 2.5 to 5.0 mm. While there are no particular limitations regarding the thickness of the correction plate 18a, a thickness of approximately 0.1 to 0.5 mm is preferable.

While in the above description the correction plate 18a of the four correction plates 18a through 18d and the side 24a of the sides 24a through 24d of the square wafer 20 are taken as an example, the above description is also applicable to the correction plates 18b, 18c, 18d and the sides 24b, 24c, 24d since they only differ from each other in their positions.

With this construction, the droplets of the treatment medium 22, such as the cleaning liquid or the treatment liquid, scattered to the outside of the square wafer 20 from the sides 24a through 24d of the square wafer 20, hit the correction plates 18a through 18d to be corrected so as to move outward away from the wafer 20, so that there is no fear of droplets of the treatment medium 22 staying in the vicinity of the square wafer 20 to be allowed to reach the back surface of the square wafer 20.

The treatment medium 22 such as the cleaning liquid or the treatment liquid, thus corrected and driven to the outside of the square wafer 20, is guided and discharged to the outside of the rotating disk 12 by the centrifugal force of the rotating disk 12 together with the treatment medium 22 guided to the outside of the square wafer 20 without being influenced by the sides 24a through 24d. In this way, the droplets of the cleaning liquid or the treatment liquid leaving the sides 24 undergo correction, whereby it is possible to prevent the cleaning liquid or the treatment liquid from reaching the back side of the wafer 20.

The operation of the surface treating apparatus 10 for a square wafer for a solar battery of the present invention will be described with reference, for example, to a case in which it is applied to spin rinsing or spin etching. First, the wafer 20 is held on the upper surface of the wafer holding part 14 of the rotating disc 12. Then, the rotating disc 12 is rotated at high speed. During the high-speed rotation, the flow-down nozzle 16 is brought close to the surface of the wafer 20 to supply the cleaning liquid or the treatment liquid as the treatment medium 22 onto the surface portion of the square wafer 20 in a downflow (FIG. 3).

The treatment medium 22 such as the treatment liquid, thus supplied in a downflow is continuously brought into contact with the square wafer 20 rotating at high speed to thereby effect rinsing or etching. At this time, due to the centrifugal force of the rotating square wafer 20, the treatment medium 22 forms a liquid flow in a direction opposite to the rotating direction of the square wafer, and is guided radially to the outside of the square wafer 20; at the sides 24a through 24d, the treatment medium 22 makes a peculiar movement and is scattered to the outside of the square wafer 20 in droplets (FIG. 3).

The droplets of the treatment medium 22 scattered from the sides 24a through 24d to the outside of the square wafer 20 hit the correction plates 18a through 18d, which are provided upright on the rotating disc 12 so as to be situated respectively in correspondence with the sides 24a, 24b, 24c, and 24d constituting the four sides of the square wafer 20, and are corrected and guided outward so as to move away from the square wafer 20. Thus, it is possible to prevent the treatment medium 22 from reaching the back surface of the square wafer 20.

For example, in the case of a 5-inch square wafer 20 whose sides 24a through 24d have a length L₂ of approximately 110 mm, there are used correction plates 18a through 18d having a length L₁ of 25 mm, a height h₁ of 2.5 to 4.0 mm, and a thickness of 0.2 to 0.5 mm, and rinsing, etching or the like is conducted, with the RPM of the rotating disc 12 set at 2500 rpm, the distance d set at 0.2 to 1.0 mm, the inclination angle α set at 15° to 20°, and the wafer surface height h₂ set at 2 mm, whereby it is possible to prevent the treatment medium 22 from reaching the back surface of the square wafer 20.

### BRIEF DESCRIPTION OF THE DRAWINGS

FIG. 1 is an explanatory perspective view of an example of the surface treating apparatus for a square wafer for a solar battery of the present invention.

FIG. 2 is an explanatory plan view of FIG. 1.

FIG. 3 is an explanatory perspective view illustrating how a square wafer is held by the surface treating apparatus for a square wafer for a solar battery of the present invention.

FIG. 4 is an explanatory plan view of FIG. 3.

FIG. 5 is an explanatory plan view showing the positional relationship between the square wafer and the correction plates in the surface treating apparatus for a square wafer for a solar battery of the present invention.

FIG. 6 is an explanatory enlarged main portion sectional view of the surface treating apparatus for a square wafer for a solar battery of the present invention.

FIG. 7 is an explanatory perspective view showing a case in which a conventional wafer surface treating apparatus is applied to the surface treatment of a square wafer.

FIG. 8 is a schematic view showing the condition of the back surface of the square wafer on which surface treatment has been conducted by the conventional wafer surface treating apparatus.

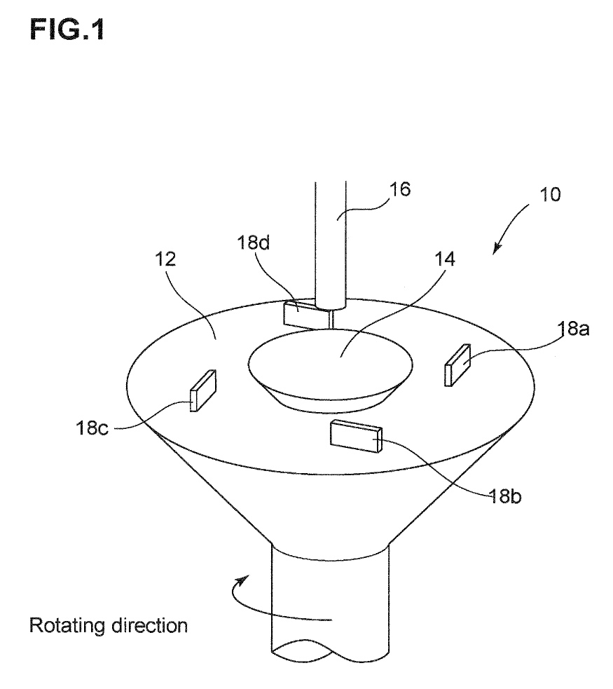

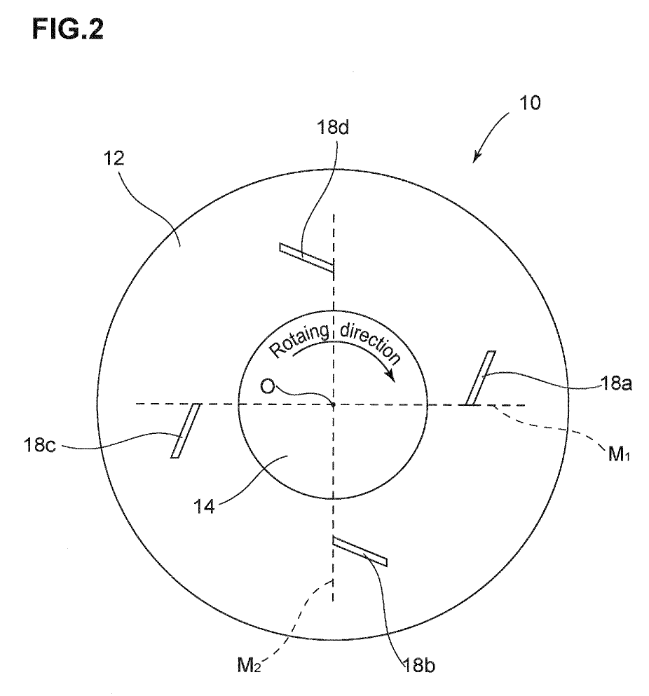

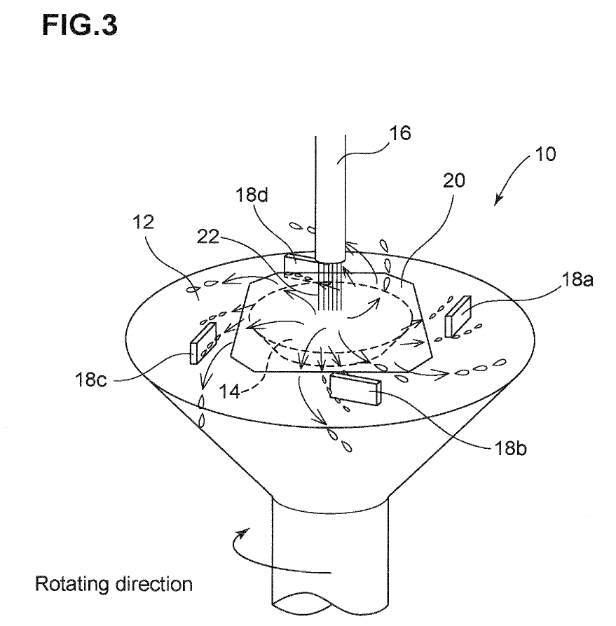

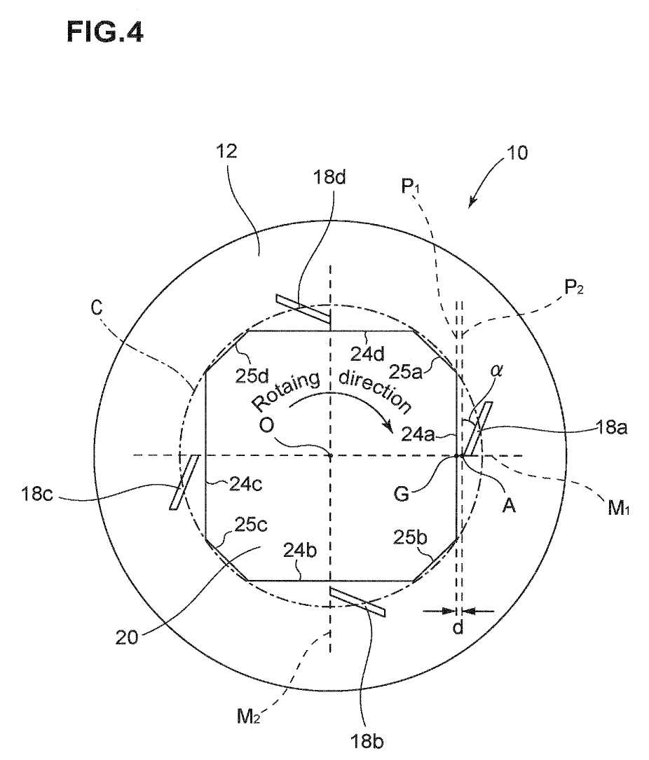

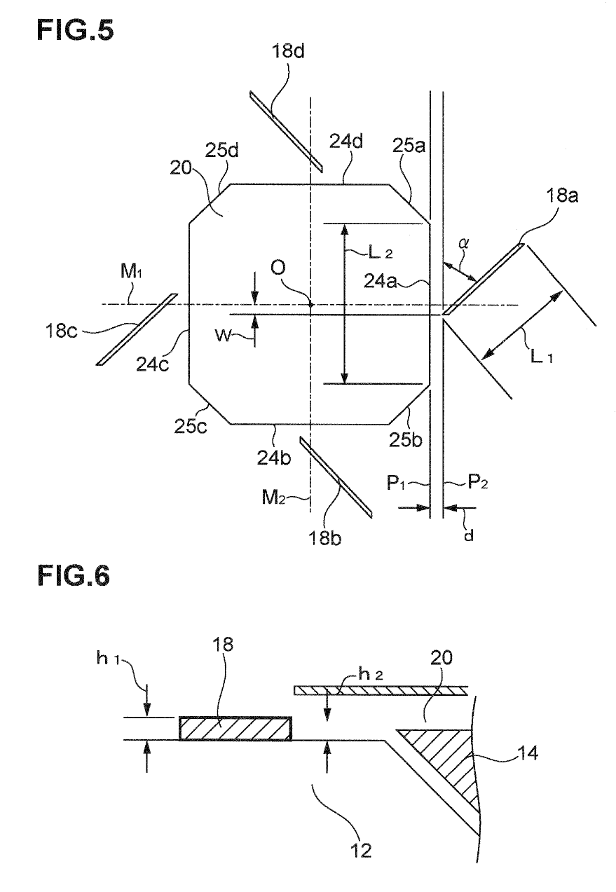

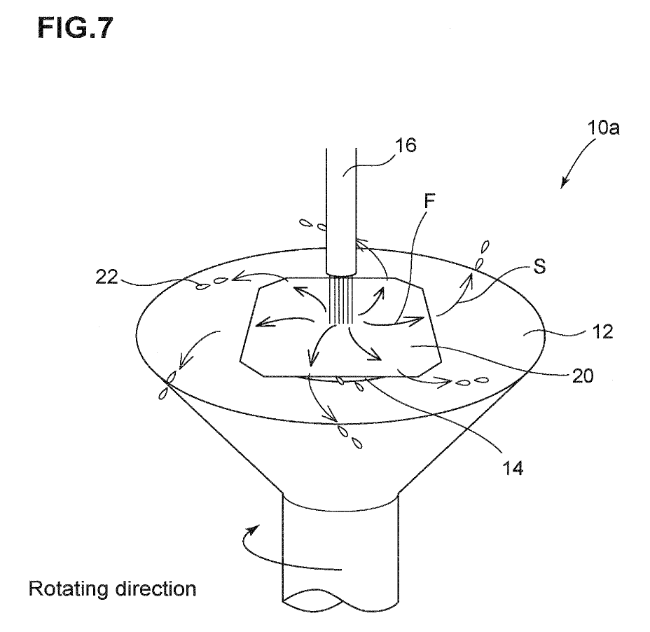

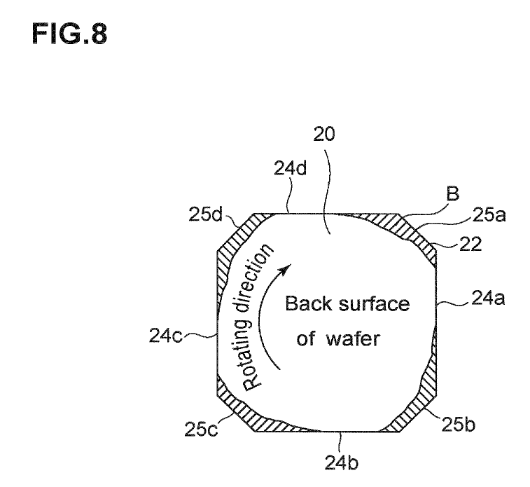

### DESCRIPTION OF REFERENCE SYMBOLS

10: surface treating apparatus for a square wafer for a solar battery of the present invention, 10a: conventional wafer surface treating apparatus, 12: rotating disc, 14: wafer holding part, 16: flow-down nozzle, 18: correction plate, 20: wafer, 22: treatment medium, 24a, 24b, 24c, 24d: sides, 25a, 25b, 25c, 25d: corner portions, A: intersecting point, B: portion on back surface reached by treatment medium, d: distance from middle point, F: liquid flow on wafer, G: middle point, h₁: height of correction plate, h₂: surface height of wafer, L₁: length of correction plate, L₂: length of side, M₁, M₂: straight lines (center lines) passing middle point G from center O, O: center, P₁: line coinciding with side, P₂: line parallel to line P₁, S: droplets of treatment medium, W: offset width, α: inclination angle of correcting plate

1. A surface treating apparatus for a square wafer for a solar battery for performing surface treatment on the square wafer for the solar battery, comprising:
a rotating disc capable of rotating at a predetermined speed;
a wafer holding part protruding from a central portion of an upper surface of the rotating disc and adapted to hold a square wafer;
a flow-down nozzle for supplying a treatment medium onto a surface of the square wafer in a downflow from above the wafer holding part; and
four correction plates provided upright on the rotating disc so that the four correction plates are situated outward respectively in correspondence with four sides of the square wafer when the surface wafer is held by the wafer holding part,
wherein, when, with the square wafer being held by the wafer holding part, the rotating disc is rotated and the treatment medium is caused to flow down onto the surface of the square wafer, it is possible to prevent the treatment medium from reaching the back surface of the square wafer.

2. The surface treating apparatus for a square wafer for a solar battery according to claim 1, wherein:
the four correction plates are provided upright such that, when the square wafer is held by the wafer holding part, a forward end in a rotating direction of each of the Four correction plates meets a straight line passing a center of the square wafer being held and a middle point between the forward end in the rotating direction and a rear end in the rotating direction of corresponding one of four sides of the wafer or is situated in the vicinity of the straight line, and is spaced apart by a predetermined distance d from the middle point between the forward end in the rotating direction and the rear end in the rotating direction of each of the four sides; and the rear end in the rotating direction of each of the four correction plates is inclined by a predetermined inclination angle α so that the four correction plates are spaced apart from the corresponding one of the four sides.

3. The surface treating apparatus for a square wafer for a solar battery according to claim 1, wherein, when the square wafer is held by the wafer holding part, the rear end in the rotating direction of each of the four correction plates extends beyond a virtual circumference C of the square wafer.

4. The surface treating apparatus for a square wafer for a solar battery according to claim 2, wherein, when the square wafer is held by the wafer holding part, the rear end in the rotating direction of each of the four correction plates extends beyond a virtual circumference C of the square wafer.

5. The surface treating apparatus for a square wafer for a solar battery according to claim 1, wherein a length L₁ of each of the four correction plates is 50% or more of a length L₂ of the corresponding one of the four sides.

6. The surface treating apparatus for a square wafer for a solar battery according to claim 2, wherein a length L₁ of each of the four correction plates is 50% or more of a length L₂ of the corresponding one of the four sides.

7. The surface treating apparatus for a square wafer for a solar battery according to claim 2, wherein the predetermined distance d is a length which is 0 mm or more but is not beyond the virtual circumference C of the square wafer.

8. The surface treating apparatus for a square wafer for a solar battery according to claim 2, wherein when the square wafer is held by the wafer holding part, the forward end in the rotating direction of each of the four correction plates is situated on a front side with respect to the rotating direction by 0 to 2 mm from the straight line passing the center of the square wafer being held and the middle point between the forward end in the rotating direction and the rear end in the rotating direction of the corresponding one of the four sides of the square wafer.

9. The surface treating apparatus for a square wafer for a solar battery according to claim 2, wherein the predetermined inclination angle α is 0° to 90°.

10. The surface treating apparatus for a square wafer for a solar battery according to claim 1, wherein, when the square wafer is held by the wafer holding part, a height h₁ of the four correction plates is larger than a surface height h₂ of the square wafer being held by 0.5 mm or more.

11. The surface treating apparatus for a square wafer for a solar battery according to claim 2, wherein, when the square wafer is held by the wafer holding part, a height h₁ of the four correction plates is larger than a surface height h₂ of the square wafer being held by 0.5 mm or more.

12. The surface treating apparatus for a square wafer for a solar battery according to claim 1, wherein the surface treatment to be conducted on a square wafer for a solar battery is spin rinsing, spin etching, spin drying, or spin coating.

13. The surface treating apparatus for a square wafer for a solar battery according to claim 2, wherein the surface treatment to be conducted on a square wafer for a solar battery is spin rinsing, spin etching, spin drying, or spin coating.

14. The surface treatment apparatus for a square wafer for a solar battery according to claim 1, wherein the treatment medium is a gas and/or a liquid.

15. The surface treating apparatus for a square wafer for a solar battery according to claim 2, wherein the treatment medium is a gas and/or a liquid.
